(19) United States
(12) Patent Application Publication
(10) Pub. No.: US 2020/0305486 A1
(43) Pub. Date: Oct. 1, 2020

(54) FOODSTUFF

(71) Applicant: MARLOW FOODS LIMITED, Stokesley (GB)

(72) Inventors: Olumuyiwa Adetokunbo AKINTOYE, Stokesley (GB); Alexander James EVANS, Stokesley (GB); Jonathan Paul MlLLER, Stokesley (GB)

(21) Appl. No.: 16/634,932

(22) PCT Filed: Dec. 17, 2018
(86) PCT No.: PCT/GB2018/053642

§ 371 Date: Jan. 29, 2020

(30) Foreign Application Priority Data
Dec. 21, 2017 (GB) 1721546.8

(51) Int. Cl. A23L 31/00; A23L 29/256; A23L 29/238

(52) U.S. Cl. CPC A23L 31/00; A23V 2002/00; A23L 29/238; A23L 29/256

(57) ABSTRACT

A foodstuff comprises particles of a filamentous fungus which is preferably a Fusarium specie, agar and an edible hydrocolloid. The foodstuff is preferably a packaged sliced product which also includes one or more flavourants. The foodstuff is preferably suitable for vegans.

This invention relates to a foodstuff and particularly, although not exclusively, relates to a foodstuff which comprises a filamentous fungus. In a preferred embodiment, the foodstuff is a meat substitute. The invention also extends to a process for making the foodstuff and a foodstuff made in the process.

It is known, for example from WO 00/15045 (DSM), WO96/21362 (Zeneca) and WO95/23843 (Zeneca) to use edible filamentous fungi as meat-substitutes, for example in the preparation of burgers and sausages. In such uses, filaments of the fungi are bound together, for example with egg albumin, and are texturised so that the product resembles muscle fibres and therefore has a meat-like appearance and texture. Meat substitutes of the type described have been widely commercially available for many years under the trade mark QUORN.

In some circumstances, it is desirable to reduce or even eliminate the amount of egg albumin used with edible fungus in the manufacture of meat-substitutes, for example, on cost grounds or to produce a product suitable for vegans.

Co-pending application number PCT/GB2017/051829 describes a foodstuff comprising particles of a filamentous fungus and agar which is suitable for consumption by vegans. Whilst the foodstuff described has been found, by a trained panel of individuals, to have acceptable performance, it is desired to improve performance.

It is an object of preferred embodiments of the present invention to address the above described problems.

It is an object of preferred embodiments of the invention to provide a vegan foodstuff of improved performance.

According to a first aspect of the invention, there is provided a foodstuff comprising particles of a filamentous fungus, agar and an edible hydrocolloid.

Unless otherwise stated, the reference to “an edible hydrocolloid” and to “said edible hydrocolloid” suitably refers to an edible hydrocolloid other than said agar.

Said foodstuff may include less than 5 wt % of agar. It may include at least 0.5 wt % or at least 1 wt % of agar. Said foodstuff may include 1-5 wt %, preferably 1.5 to 4.0 wt %, more preferably 2.0 to 3.2 wt %, especially 2.1 to 3.0 wt % agar. For the avoidance of doubt, references to amounts of agar herein are on a dry matter basis—i.e. excluding any water that may be included in the agar.

Said foodstuff may include 60 to 95 wt % of added filamentous fungus on a wet matter basis. Said “wet” filamentous fungus is suitably mycoprotein paste referred to hereinafter. Said foodstuff may include 74 to 90 wt % of added filamentous fungus on said wet matter basis.

Said foodstuff may include at least 8 wt % of said filamentous fungus on a dry matter basis. Said foodstuff may include at least 12 wt %, preferably at least 15 wt % of said filamentous fungus on a dry matter basis. Said foodstuff may include less than 25 wt %, preferably less than 23 wt % or less than 22 wt % of said filamentous fungus on a dry matter basis.

Said foodstuff may include 8 to 25 wt %, preferably 15 to 24 wt % of said filamentous fungus on a dry matter basis.

In said foodstuff, a ratio (A) defined as the weight of filamentous fungus on a dry matter basis divided by the weight of agar may be at least 4, preferably at least 5, more preferably at least 6, especially at least 7. Ratio (A) may be less than 15, suitably less than 10, preferably less than 9, more preferably less than 8.

Ratio (A) may be in the range 5 to 10, preferably in the range 6.0 to 8.5, more preferably in the range 6.5 to 8.5, especially in the range 7 to 8.

Said foodstuff may include less than 2 wt % or less than 1 wt % of said edible hydrocolloid. It may include at least 0.09 wt % or at least 0.18 wt % of said edible hydrocolloid. Said foodstuff may include 0.18 to 0.88 wt %, preferably 0.26 to 0.71 wt %, more preferably 0.35 to 0.56 wt %, especially 0.37 to 0.53 wt % of said edible hydrocolloid.

In said foodstuff, a ratio (B) defined as the weight of the filamentous fungus on a dry matter basis divided by the weight of said edible hydrocolloid may be at least 0.70, preferably at least 0.85, more preferably at least 1.06, especially at least 1.23. Ratio (B) may be less than 2.70, suitably less than 1.76, preferably less than 1.59, more preferably less than 1.41.

Ratio (B) may be in the range 1 to 2, preferably in the range 1 to 1.7, more preferably in the range 1.1 to 1.6.

The total amount of edible hydrocolloid(s), excluding agar (referred to as “non-agar hydrocolloid”), in said foodstuff may be less than 1 wt %. Said foodstuff may include at least 0.09 wt % or at least 0.18 wt % of non-agar hydrocolloid. Said foodstuff may include 0.18 to 0.88 wt %, preferably 0.26 to 0.71 wt %, more preferably 0.35 to 0.56 wt %, especially 0.37 to 0.53 wt % of non-agar hydrocolloid.

In said foodstuff, a ratio (C) defined as the weight of the filamentous fungus on a dry matter basis divided by the weight of non-agar hydrocolloid may be at least 20, preferably at least 25, more preferably at least 30, especially at least 35. Ratio (C) may be less than 75, suitably less than 50, preferably less than 45, more preferably less than 40.

Ratio (C) may be in the range 25 to 50, preferably in the range 30 to 42.

Said fungal particles suitably comprise an edible filamentous fungus. Said filamentous fungus preferably comprises fungal mycelia and suitably at least 80 wt %, preferably at least 90 wt %, more preferably at least 95 wt % and, especially, at least 99 wt % of the fungal particles in said foodstuff comprise fungal mycelia. Some filamentous fungi may include both fungal mycelia and fruiting bodies. Said fungal particles preferably comprise a filamentous fungus of a type which does not produce fruiting bodies. Where, however, a filamentous fungus of a type which produces fruiting bodies is used, the fungal particles in said foodstuff suitably include at least 80 wt %, preferably at least 90 wt %, more preferably at least 95 wt % of fungal mycelia. Preferably, said fungal particles comprise substantially only fungal mycelia—that is, said fungal particles in said foodstuff preferably do not include any fruiting bodies.

Preferred fungi for said fungal particles have a cell wall which includes chitin and/or chitosan. Preferred fungi have a cell wall which includes polymeric glucosamine. Preferred fungi have a cell wall which includes β1-3 and 1-6 glucans.

Said fungal particles preferably comprise (preferably consist essentially of) fungus, for example selected from fungi imperfecti.

Preferably, said fungal particles comprise, and preferably consist essentially of, cells of Fusarium species, especially of Fusarium venenatum A3/5 (formerly classified as Fusarium graminearum) (IMI 145425; ATCC PTA-2684 deposited with the American Type Culture Collection, 10801 University Boulevard, Manassas, Va.) as described for example in WO96/21361 (Zeneca) and WO95/23843 (Zeneca).

Preferably, said fungal particles are non-viable. Preferably, said fungal particles have been treated to lower the level of RNA which they contain. Thus, the level of RNA in the fungal particles used is preferably less than the level in an identical fungus when in a viable state.

The level of RNA in the fungal particles is preferably less than 2 wt % on a dry matter basis.

Fungal particles in said foodstuff may comprise filaments having lengths of less than 1000 μm, preferably less than 800 μm. Said filaments may have a length greater than 100 μm, preferably greater than 200 μm. Preferably, fewer than 5 wt %, preferably substantially no, fungal particles in said foodstuff have lengths of greater than 5000 μm; and preferably fewer than 5 wt %, preferably substantially no, fungal particles have lengths of greater than 2500 μm. Preferably, values for the number average of the lengths of said fungal particles in said foodstuff are also as stated above.

Fungal particles in said foodstuff may comprise filaments having diameters of less than 20 μm, preferably less than 10 μm, more preferably 5 μm or less. Said filaments may have diameters greater than 1 μm, preferably greater than 2 μm. Preferably, values for the number average of said diameters of said fungal particles in said foodstuff are also as stated above.

Fungal particles in said foodstuff may comprise filaments having an aspect ratio (length/diameter) of less than 1000, preferably less than 750, more preferably less than 500, especially of 250 or less. The aspect ratio may be greater than 10, preferably greater than 40, more preferably greater than 70. Preferably, values for the average aspect ratio of said fungal particles (i.e. the average of the lengths of the particles divided by the average of the diameters of the fungal particles) in said foodstuff are also as stated above.

Unless otherwise stated, gel strength is measured using the following test:

Gel Strength Test:

400 ml of an aqueous 1 wt % solution of a selected agar was prepared and boiled for 10 minutes (time started once solution reached 99° C.). After boiling, the agar was poured into a gel jar and allowed to set overnight in an incubator at 20° C. The resulting gel was assessed using a TA-XT texture analyser with an AOAC gelatin probe. The test speed was set at 0.5 mm/s second over a 20 mm distance. The maximum gel strength was calculated as the highest gel strength before the gel “broke” or began to decrease in force.

Said agar may have a gel strength of at least 500 g/cm³, suitably at least 700 g/cm³ or at least 900 g/cm³. The gel strength, measured as aforesaid, may be less than 2000 g/cm³, less than 1500 g/cm³ or less than 1200 g/cm³. Preferably the gel strength is in the range 900 g/cm³ to 1200 g/cm³, preferably in the range 1000 g/cm³ to 1200 g/cm³.

Said edible hydrocolloid may be selected from alginate, arabinoxylan, carrageenan, carboxymethylcellulose, cellulose, curdlan, gelatin, gellan, β-Glucan, a galactomannan, guar gum, locust bean gum, tara gum, gum arabic, pectin, konjac gum, starch, and xanthan gum.

Said edible hydrocolloid may be selected from carrageenan, carboxymethylcellulose, guar gum, locust bean gum, tara gum, gum arabic, konjac gum and xanthan gum.

Said edible hydrocolloid may be selected from carboxymethylcellulose, guar gum, locust bean gum, tara gum, and konjac gum.

Said edible hydrocolloid is preferably not of animal original. It preferably includes no ingredients derived from animals.

Said edible hydrocolloid is preferably locust bean gum (LBG). In said foodstuff, a ratio (D) defined as the weight of the filamentous fungus on a dry matter basis divided by the weight of LBG may be at least 20, preferably at least 25, more preferably at least 30, especially at least 35. Ratio (D) may be less than 75, suitably less than 50, preferably less than 45, more preferably less than 40.

Ratio (D) may be in the range 20 to 50, preferably in the range 25 to 45.

In said foodstuff, a ratio (E) defined as the weight of the filamentous fungus on a dry matter basis divided by the sum of the wt % of hydrocolloids other than agar in said foodstuff may be at least 20, preferably at least 25, more preferably at least 30, especially at least 35. Ratio (E) may be less than 75, suitably less than 50, preferably less than 45, more preferably less than 40.

Ratio (E) may be in the range 20 to 50, preferably in the range 25 to 45.

In said foodstuff, a ratio (F) defined as the weight of filamentous fungus on a dry matter basis divided by the sum of the amounts of agar and said edible hydrocolloid (especially LBG) may be in the range 4-9, preferably in the range 5-8.

In said foodstuff, a ratio (G) defined as the weight of filamentous fungus on a dry matter basis divided by the sum of the amounts of agar and any other edible hydrocolloid in said foodstuff may be in the range 4-9, preferably in the range 5-8.

In said foodstuff, a ratio (H) defined as the weight of agar divided by the weight of said edible hydrocolloid may be in the range 0.5 to 10, preferably in the range 2 to 10, more preferably in the range 3 to 8.

In said foodstuff, a ratio (I) defined as the weight of agar divided by the sum of the amounts of agar and any other edible hydrocolloid in said foodstuff may be in the range 0.5 to 10, preferably in the range 2 to 10, more preferably in the range 3 to 8.

In said foodstuff, a ratio (J) defined as the weight of water divided by the weight of filamentous fungus on a dry matter basis may be in the range 2.0 to 5, preferably in the range 2.1 to 4.0.

The total amount of water in said foodstuff may be at least 25 wt %, preferably at least 30 wt %, more preferably at least 50 wt %, especially at least 60 wt %. The total amount of water may be less than 80 wt %.

The total amount of water in said foodstuff may be in the range 25 to 81 wt %, preferably in the range 40 to 81 wt %, more preferably in the range 60 to 80 wt %.

Said foodstuff may include:
12 to 25 wt % of said filamentous fungus on a dry matter basis;
1 to 4 wt % of agar;
30 to 85 wt % of water; and
0.1 to 2 wt % of said edible hydrocolloid.

Preferably, said foodstuff includes:
15 to 24 wt % of said filamentous fungus on a dry matter basis;
2 to 4 wt % of agar;
55 to 80 wt % of water; and
0.2 to 0.9 wt % of said edible hydrocolloid.

Said foodstuff may include other ingredients. For example, said foodstuff may include a vegetable-based protein for example potato protein. Said foodstuff may include 0 to 3 wt %, preferably 0.5 to 3 wt %, more preferably 1 to 3 wt % of said vegetable-based protein, especially potato protein. Said package may fully enclose said foodstuff.

Said foodstuff may have a pH of less than 6 or less than 5. The pH may be at least 3, preferably at least 4. Preferably, the pH is in the range 4-5.

The foodstuff may include one or more ingredients added to adjust the pH of the foodstuff. Preferably, the foodstuff includes an acidulant. Said foodstuff may include at least 0.5 wt % of acidulant. It may include less than 2 wt % of acidulant.

The foodstuff may include one or more flavourants. In said foodstuff, the total amount of added flavourants may be at least 1 wt %, preferably at least 2 wt %. The total amount may be less than 4 wt %.

Said foodstuff may include a preservative at a level of less than 0.25 wt %. It may include at least 0.05 wt % of said preservative which may be a sorbate.

Said foodstuff may include:
17 to 22 wt % of filamentous fungus on a dry matter basis;
1 to 5 wt % (preferably 2 to 3 wt %) of agar;
0 to 3 wt % (preferably 1 to 2.5 wt %) of vegetable-based protein, for example potato protein;
1 to 4 wt % (preferably 1 to 3.5 wt %) in total of one or more flavourants;
0 to 0.2 wt % of preservative;
63.8 to 80.5 wt % (preferably 65.8 to 78.5 wt %) water; and
0.2 to 0.9 wt % of said edible hydrocolloid.

Said foodstuff preferably includes less than 5 wt %, preferably 0 wt %, of egg albumin.

Said foodstuff preferably includes less than 5 wt %, preferably 0 wt %, of ingredients of animal origin.

Said foodstuff is preferably suitable for vegans. It preferably includes 0 wt % of components derived from animals.

Said foodstuff is preferably a meat-substitute which suitably includes no meat.

Said foodstuff preferably comprises a sliced product. Said foodstuff preferably comprises a multiplicity of slices. The slices preferably have substantially identical compositions. The slices preferably have substantially identical thicknesses which may be less than 2 mm, preferably less than 1 mm; and may be at least 0.1 mm. The slices preferably have a substantially identical cross-sectional shape. The slices preferably have a substantially identical cross-sectioned shape and size.

Said foodstuff is preferably provided in a package. For example at least 2 slices (and suitably less than 25 slices) may be provided in said package. The package may be arranged to restrict passage of oxygen to the foodstuff therein. Said package may comprise a plastics packaging material.

Said foodstuff is preferably the only foodstuff contained in the package.

According to a second aspect of the invention, there is provided a process for making a foodstuff, the process comprising:
(i) selecting particles of filamentous fungus;
(ii) selecting agar and an edible hydrocolloid;
(iii) contacting said particles of filamentous fungus with said agar and said edible hydrocolloid.

Said foodstuff may have any feature of the foodstuff of the first aspect. Said filamentous fungus may have any feature of the foodstuff of the first aspect. Said agar may have any feature of the foodstuff of the first aspect. Said hydrocolloid may have any feature of the foodstuff of the first aspect.

In step (i) a biomass comprising filamentous fungus is suitably selected. Said biomass may be in the form of a paste. Said biomass may include 20-30 wt %, (preferably 22-26 wt %) of filamentous fungus on a dry matter basis and 70-80 wt %, (preferably 74 to 78 wt %) of water.

Said agar is suitably in a powder form. Said edible hydrocolloid is suitably in a powder form.

Said particles of filamentous fungus may be contacted with a mixture comprising agar and said edible hydrocolloid.

The process may comprise selecting 30 to 95 wt %, preferably 70 to 90 wt %, more preferably 75 to 85 wt % of said biomass and contacting it with 1 to 5 wt % of said agar and 0.1 to 2 wt % of edible hydrocolloid.

Other ingredients (e.g. additional water, flavourants, preservatives, acidulant and/or vegetable protein) may also be contacted with filamentous fungus in step (iii) or subsequent thereto.

In step (iii), said particles of filamentous fungus, said agar and said edible hydrocolloid are preferably mixed, optionally in the presence of other ingredients, preferably to produce a substantially homogenous mass.

After step (iii), a mixture comprising said filamentous fungus, agar and said edible hydrocolloid (e.g. said substantially homogenous mass described) is preferably introduced into a receptacle or mould, suitably to form said mixture (e.g. said homogenous mass) into a predetermined shape. The receptacle is preferably elongate and suitably has a substantially contact cross-section along its extent, e.g. along at least 80% of its length. Said receptacle may be tubular. It may comprise a tubular casing.

After step (iii), suitably with said mixture (e.g. homogenous mass) in said receptacle (e.g. casing), said mixture is preferably subjected to an elevated temperature (e.g. greater than 50° C. and preferably in the range 70-100° C.), for example to cook the mixture. In the process, said mixture may be subjected to said temperature for at least 10 minutes and preferably less than 120 minutes. More preferably, it is subjected to said temperature for 15 to 120 minutes.

After step (iii) and preferably after said mixture has been subjected to said elevated temperature as described, said mixture is subjected to a reduced temperature of less than 0° C., preferably less than −4° C., more preferably less than −15° C. It may be subjected to a temperature in the range −4° C. to −25° C., for example in the range −15° C. to −25° C. As a result, said mixture may be frozen.

In the process, said mixture is preferably subjected to said reduced temperature for at least 24 hours, preferably at least 96 hours. It may be subjected to said reduced temperature for at least 1 week, at least 2 weeks or at least 3 weeks. Subsequently, the temperature of said mixture is raised, for example to 0 to 10° C.

After being subjected to said reduced temperature and suitably after said temperature has been raised, for example to 0 to 10° C., said mixture may be fragmented, for example sliced, suitably to define a multiplicity of substantially identical slices. Prior to fragmentation (e.g. slicing), said mixture is suitably removed from said receptacle.

After fragmentation (e.g. slicing) said mixture (which suitably has any feature of the foodstuff of the first aspect) is preferably packaged. After packaging, it may be refrigerated (e.g. held at a temperature in the range 0 to 5° C.).

The product of the process of the second aspect is novel. Thus, in a third aspect, the invention extends to a product of the process of the second aspect per se.

Any feature of any aspect of any invention described herein may be combined with any feature of any other invention described herein mutatis mutandis.

Specific embodiments of the invention will now be described, by way of example.

Mycoprotein paste—Mycoprotein paste-refers to a visco-elastic material comprising a mass of edible filamentous fungus derived from Fusarium venenatum A3/5 (formerly classified as Fusarium graminearum Schwabe) (IMI 145425; ATCC PTA-2684 deposited with the American type Culture Collection, 12301 Parklawn Drive, Rockville Md. 20852) and treated to reduce its RNA content to less than 2% by weight by heat treatment. Further details on the material are provided in WO96/21362 and WO95/23843. The material may be obtained from Marlow Foods Limited of Stokesley, U.K. It comprises about 23-25 wt % solids (the balance being water) made up of non-viable RNA reduced fungal hyphae of approximately 400-750 μm length, 3-5 μm in diameter and a branching frequency of 2-3 tips per hyphal length.

Agar—commercially-available powdered agar for food applications having a gel strength (1.5 wt % solution at 20° C.) of approximately 800-1100 g/cm².

In the following, Example 1 describes a general process for preparing a sliced, cold, meat-free (but meat-like) product; Examples 2 and 5 are comparative examples based on the disclosure in PCT/GB2017/051829. Examples 3 and 6 are examples of preferred embodiments. Examples 4 and 7 provide results of sensory analyses. Example 8 describes other gums.

### EXAMPLE 1—GENERAL PROCEDURE FOR PREPARATION OF SLICED, COLD, MEAT-FREE (BUT MEAT-LIKE) PRODUCT

Mycoprotein paste was weighed into a mixing bowl of a food mixer and water was added, prior to mixing for about 1 minute. Then, all the dry ingredients to be included were added and mixed for a few minutes. Periodically, mixing was stopped to redistribute materials that were stood away from the impeller. Mixing was continued in order to achieve an even distribution of all ingredients within the mix. Once achieved, mixing was stopped and the material was filled into chub sausage casings using a manual sausage filler. Chubs were then transferred into a steamer and cooked at 100° C. for about 60 minutes or longer to achieve a core temperature of 98-100° C. After steaming, the cooked chub was transferred to a blast freezer and left to freeze for around 120 minutes. The frozen chub was then located inside a marked sample bag, transferred into a cold store and held there at −21° C. for around a week before defrosting for evaluation.

Subsequently, defrosted samples of products were thinly sliced, for example in the range 1-3 mm, to define a sliced meat-like product.

### EXAMPLE 2—PREPARATION OF FIRST AGAR-BASED, SLICED, COLD, MEAT-FREE (BUT MEAT-LIKE), VEGAN, HAM FLAVOURED PRODUCT (COMPARATIVE EXAMPLE)

Following the procedure described in Example 1, an agar-based product was made. A summary of the recipe is provided in the table below.

| Ingredient | Wt % |
|---|---|
| Mycoprotein paste | 79.29 |
| Water | 10.00 |
| Potassium sorbate | 0.24 |
| Potato protein | 1.41 |
| Flavour and salt | 4.00 |
| Acid Masker | 1.29 |
| Agar | 3.06 |
| Vegetable fibre | 0.71 |

### EXAMPLE 3—PREPARATION OF SECOND AGAR-BASED, SLICED, COLD, MEAT-FREE (BUT MEAT-LIKE), VEGAN HAM-FLAVOURED PRODUCT

Following the procedure described in Example 1, a ham-like agar-based product was made, using the following recipe.

| Ingredient | Wt % |
|---|---|
| Mycoprotein paste | 79.29 |
| Water | 10.00 |
| Potassium sorbate | 0.24 |
| Potato protein | 1.41 |
| Flavour and salt | 4.00 |
| Acid masker | 1.29 |
| Mixture comprising Agar and Locust Bean | 3.06 |
| Gum in a weight ratio of 85:15 | |
| Vegetable fibre | 0.71 |

### EXAMPLE 4—COMPARISON OF PRODUCTS OF EXAMPLES 2 AND 3

Sensory evaluation of the products of Examples 2 and 3 was undertaken using a consumer panel comprising 9 meat-eaters and 9 vegetarians, all of which were regular consumers of QUORN (Trade Mark) products.

The defrosted, sliced products were generously filled into sandwiches and served in a balanced order and assessed by the panel. Monadic scores for Examples 2 and 3 for “overall liking”, “overall texture” and “overall taste” are presented in the table below.

| Example | Overall Liking | Overall Texture | Overall taste |
|---|---|---|---|
| No | (%) | (%) | (%) |
| 2 | 61 | 61 | 62 |
| 3 | 68 | 72 | 69 |

The results show that the Example 3 product was preferred compared to the Example 2 product.

### EXAMPLE 5—PREPARATION OF FIRST AGAR-BASED, SLICED, COLD, MEAT-FREE (BUT MEAT-LIKE), VEGAN, CHICKEN FLAVOURED PRODUCT (COMPARATIVE EXAMPLE)

Following the procedure described in Example 1, an agar-based product was made. A summary of the recipe is provided in the table below.

| Ingredient | Wt % |
|---|---|
| Mycoprotein paste | 80.9 |
| Water | 10.0 |
| Meat-free chicken flavour | 2.8 |
| Potassium sorbate | 0.2 |
| Acidulant | 1.1 |
| Agar powder | 3.6 |
| Potato protein | 1.4 |

### EXAMPLE 6—PREPARATION OF SECOND AGAR-BASED, SLICED, COLD, MEAT-FREE (BUT MEAT-LIKE), VEGAN CHICKEN-FLAVOURED PRODUCT

Following the procedure described in Example 1, a modified agar-based product was made with ingredients as described in the table below.

| Ingredient | Wt % |
|---|---|
| Mycoprotein paste | 82.90 |
| Water | 10.01 |
| Meat-free chicken flavour | 2.83 |
| Potassium sorbate | 0.20 |
| Acid masker | 1.00 |
| Mixture comprising Agar and Locust Bean | 3.06 |
| Gum in a weight ratio of 85:15 | |

### EXAMPLE 7—COMPARISON OF PRODUCTS OF EXAMPLES 5 AND 6

The products were assessed as described in Example 4 and it was found that the Example 6 product was significantly preferred over the Example 5 product.

### EXAMPLE 8—ALTERNATIVES TO LOCUST BEAN GUM

The locust bean gum in Example 3 was replaced with alternative gums, namely carboxymethylcellulose, tara gum, konjac gum and guar gum and it was found that acceptable products were produced. However, products including locust bean gum as described are preferred.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A foodstuff comprising particles of a filamentous fungus, agar and an edible hydrocolloid.

2. The foodstuff according to claim 1, wherein said foodstuff includes 2.0 to 3.2 wt % agar.

3. The foodstuff according to claim 1, wherein said foodstuff includes at least 8 wt % of said filamentous fungus on a dry matter basis; and includes less than 25 wt % of said filamentous fungus on a dry matter basis.

4. The foodstuff according to claim 1, wherein, in said foodstuff, a ratio (A) defined as the weight of filamentous fungus on a dry matter basis divided by the weight of agar, is at least 4; and, a ratio (B) defined as the weight of the filamentous fungus on a dry matter basis divided by the weight of said edible hydrocolloid is at least 0.70.

5. The foodstuff according to claim 1, wherein, in said foodstuff, the total amount of edible hydrocolloids, excluding agar (referred to as “non-agar hydrocolloid”) is in the range 0.18 to 0.88 wt %.

6. The foodstuff according to claim 5, wherein, in said foodstuff, a ratio (C) defined as the weight of the filamentous fungus on a dry matter basis divided by the weight of non-agar hydrocolloid is at least 20; and is less than 75.

7. The foodstuff according to claim 1, wherein said fungal particles comprise fungus selected from fungi imperfecti.

8. The foodstuff according to claim 1, wherein said agar has a gel strength of at least 500 g/cm³.

9. The foodstuff according to claim 1, wherein said edible hydrocolloid is selected from alginate, arabinoxylan, carrageenan, carboxymethylcellulose, cellulose, curdlan, gelatin, gellan, β-Glucan, a galactomannan, guar gum, locust bean gum, tara gum, gum arabic, pectin, konjac gum, starch, and xanthan gum.

10. The foodstuff according to claim 1, wherein said edible hydrocolloid is not of animal origin.

11. The foodstuff according to claim 1, wherein said edible hydrocolloid is locust bean gum (LBG).

12. The foodstuff according to claim 11, wherein, in said foodstuff, a ratio (D) defined as the weight of the filamentous fungus on a dry matter basis divided by the weight of LBG is at least 20 and is less than 75.

13. The foodstuff according to claim 1, wherein, in said foodstuff, a ratio (E) defined as the weight of the filamentous fungus on a dry matter basis divided by the sum of the wt % of hydrocolloids other than agar in said foodstuff is in the range 20 to 50; and/or a ratio (F) defined as the weight of filamentous fungus on a dry matter basis divided by the sum of the amounts of agar and said edible hydrocolloid (especially LBG) is in the range 4-9; and/or a ratio (G) defined as the weight of filamentous fungus on a dry matter basis divided by the sum of the amounts of agar and any other edible hydrocolloid in said foodstuff is in the range 4-9; and/or a ratio (H) defined as the weight of agar divided by the weight of said edible hydrocolloid is in the range 3 to 8; and/or a ratio (I) defined as the weight of agar divided by the sum of the amounts of agar and any other edible hydrocolloid in said foodstuff is in the range 3 to 8; and/or a ratio (J) defined as the weight of water divided by the weight of filamentous fungus on a dry matter basis is in the range 2.0 to 5.0.

14. The foodstuff according to claim 1, wherein the total amount of water in said foodstuff is at least 25 wt %; and is less than 80 wt %.

15. The foodstuff according to claim 1, wherein said foodstuff includes:
12 to 25 wt % of said filamentous fungus on a dry matter basis;
1 to 4 wt % of agar;
30 to 85 wt % of water; and
0.1 to 2 wt % of said edible hydrocolloid.

16. The foodstuff according to claim 15, wherein said foodstuff includes 0 wt % of ingredients of animal origin.

17. The foodstuff according to claim 1, wherein said foodstuff includes:
2.0 to 3.2 wt % agar;
at least 8 wt % of said filamentous fungus on a dry matter basis; and less than 25 wt % of said filamentous fungus on a dry matter basis;
a ratio (A) defined as the weight of filamentous fungus on a dry matter basis divided by the weight of agar in the range 6.5 to 8.5;
0.26 to 0.71 wt % of said edible hydrocolloid;
0.18 to 0.88 wt % of edible hydrocolloids other than agar;
a ratio (C) defined as the weight of the filamentous fungus on a dry matter basis divided by the weight of edible hydrocolloids other than agar of at least 20; and less than 75.

18. The foodstuff according to claim 1, wherein:
said agar has a gel strength of at least 500 g/cm³;
said edible hydrocolloid is locust bean gum (LBG); and
in said foodstuff, a ratio (D) defined as the weight of the filamentous fungus on a dry matter basis divided by the weight of LBG is in the range 20 to 50.

19. A foodstuff comprising particles of a filamentous fungus, agar and an edible hydrocolloid, wherein said foodstuff includes:
12 to 25 wt % of said filamentous fungus on a dry matter basis;
2 to 3.2 wt % of agar;
30 to 85 wt % of water;
0.1 to 2 wt % of said edible hydrocolloid;
0 wt % of ingredients of animal origin;
a ratio (A) defined as the weight of filamentous fungus on a dry matter basis divided by the weight of agar in the range 6.5 to 8.5;
a ratio (B) defined as the weight of the filamentous fungus on a dry matter basis divided by the weight of said edible hydrocolloid in the range 1 to 1.7;
a total amount of edible hydrocolloids, excluding agar, in the range 0.18 to 0.88 wt %.

20. A process for making a foodstuff according to claim 1, the process comprising:
(i) selecting particles of filamentous fungus;
(ii) selecting agar and an edible hydrocolloid;
(iii) contacting said particles of filamentous fungus with said agar and said edible hydrocolloid.
